(19) United States
(12) Patent Application Publication
(10) Pub. No.: US 2011/0078180 A1
(43) Pub. Date: Mar. 31, 2011

(54) INFORMATION ACQUIRING TERMINAL APPARATUS, AND METHOD AND RECORDING MEDIUM STORING AN INFORMATION ACQUISITION

(75) Inventor: Tomofumi NAKAYAMA, Tokoname-shi (JP)

(73) Assignee: BROTHER KOGYO KABUSHIKI KAISHA, Nagoya-shi (JP)

(21) Appl. No.: 12/894,103

(22) Filed: Sep. 29, 2010

(30) Foreign Application Priority Data
Sep. 30, 2009 (JP) 2009-228369

(51) Int. Cl. G06F 17/30

(52) U.S. Cl. 707/769; 707/E17.014

(57) ABSTRACT

An information acquiring terminal apparatus that acquires information through a line that charges on basis of a given charge system based on at least one of a communication distance and a communication time, includes: an acquisition subject attribute setting portion that sets an attribute of information to acquire depending on input by a user; an acquisition condition setting portion that sets an acquisition condition including a condition on a maximum charge amount at information acquisition depending on input by the user; an acquisition subject determining portion that based on a communication condition in a case of acquiring each acquisition candidate information matching an attribute set by the acquisition subject attribute setting portion, determines the acquisition candidate information satisfying the acquisition condition to be acquisition subject information; and an acquiring portion that acquires the acquisition subject information through the line.

### BACKGROUND OF THE INVENTION

1. Field of the Invention

The present invention relates generally to an information acquiring terminal apparatus, and, more particularly, to an information acquiring terminal apparatus that acquires information through a line that charges depending on a communication distance and a communication time, a method for the information acquisition, and a recording medium storing the information acquisition to be executed by a computer.

2. Description of the Related Art

An information acquiring terminal apparatus is known, which acquires information through a line that charges on the basis of a given charging system based on at least one of a communication distance and a communication time. Such an information acquiring terminal apparatus accesses an information providing terminal apparatus, a server, etc., (hereinafter “partner apparatus”) retaining information to acquire, in other words, desired information through the line to communicate with the partner apparatus, thus acquires the desired information.

A technique has been disclosed, according to which, in the case of acquiring electronic information via a communication network, when a user inputs data corresponding to information on an electronic information source provider to send a distribution request to the provider, a data processor disposed on the communication network system receives the distribution request temporarily, analyzes data requested by the distribution request, and sends access information for communication with the provider back to the user.

In some cases, a communication partner to an information acquiring terminal apparatus, that is, a partner apparatus retaining and providing desired information is distant from the information acquiring terminal apparatus, and the volume of information to acquire is large to make a communication time longer. In such cases, a longer communication distance or communication time leads to a problem that using a line that charges based on at least one of a communication time and a communication distance may result in a higher charge amount.

### SUMMARY OF THE INVENTION

The present invention was conceived in view of the circumstances, and it is therefore the object of the preset invention to provide an information acquiring terminal apparatus capable of determining information to acquire based on an acquisition condition including a condition on a charge amount in information acquisition.

According to a first aspect of the present invention for achieving the object, (a) an information acquiring terminal apparatus that acquires information through a line that charges on the basis of a given charge system based on at least one of a communication distance and a communication time includes (b) an acquisition subject attribute setting portion that sets the attribute of information to acquire depending on input by a user, (c) acquisition condition setting portion that sets an acquisition condition including a condition on a maximum charge amount at information acquisition depending on input by the user, (d) an acquisition subject determining portion that based on a communication condition in the case of acquiring each acquisition candidate information matching an attribute set by the acquisition subject attribute setting portion, determines each acquisition candidate information satisfying the acquisition condition to be acquisition subject information, and (e) an acquiring portion that acquires the acquisition subject information through the line.

According to a second aspect of the present invention, (a) an information acquiring method of acquiring information through a line that charges on the basis of a given charge system based on at least one of a communication distance and a communication time includes (b) an acquisition subject attribute setting step of setting the attribute of information to acquire depending on input by a user, (c) an acquisition condition setting step of setting an acquisition condition including a condition on a maximum charge amount at information acquisition depending on input by the user, (d) an acquisition subject determining step of determining each acquisition candidate information satisfying the acquisition condition to be acquisition subject information, based on a communication condition in the case of acquiring each acquisition candidate information matching an attribute set by the acquisition subject attribute setting portion, and (e) an acquiring step of acquiring the acquisition subject information through the line.

According to a third aspect of the present invention, (a) an information recording medium stores an information acquiring program that causes a computer to acquire an information through a line that charges on the basis of a given charge system based on at least one of a communication distance and a communication time. The information acquiring program causes the computer to function as (b) an acquisition subject attribute setting portion that sets the attribute of information to acquire depending on input by a user, (c) an acquisition condition setting portion that sets an acquisition condition including a condition on a maximum charge amount at information acquisition depending on input by the user, (d) an acquisition subject determining portion that based on a communication condition in the case of acquiring each acquisition candidate information matching an attribute set by the acquisition subject attribute setting portion, determines each acquisition candidate information satisfying the acquisition condition to be acquisition subject information, and (e) an acquiring portion that acquires the acquisition subject information through the line.

### BRIEF DESCRIPTION OF THE DRAWINGS

FIG. 1 is an explanatory diagram of an example of connection of an information acquiring terminal apparatus of the present invention via a communication line;

FIG. 2 is a block diagram for explaining an example of a configuration of the information acquiring terminal apparatus of FIG. 1 and a schematic of functions of a control portion incorporated in the information acquiring terminal apparatus;

FIG. 3 is an explanatory diagram of an example of display made on a touch panel display of the information acquiring terminal when an attribute is set by an acquisition subject attribute setting portion;

FIG. 4 is an explanatory diagram of an example of display made on the touch panel display of the information acquiring terminal when an acquisition condition is set by an acquisition condition setting portion;

FIG. 5 is an explanatory diagram of an example of an acquisition condition/attribute table having stored therein an attribute set by the acquisition subject attribute setting portion and acquisition conditions set by the acquisition condition setting portion;

FIG. 6 is an explanatory diagram of an example of an image quality table that defines image qualities which are image properties;

FIG. 7 depicts an example of an acquisition candidate information table indicating management information given by extraction of acquisition candidate information by an acquisition candidate information extracting portion and calculation of a charge amount as a communication condition by a communication condition calculating portion;

FIG. 8 depicts an example of an acquisition subject table indicating a list of images that are determined to be acquisition subject by an acquisition subject determining portion;

FIG. 9 is a flowchart for explaining an example of control operation carried out by the information acquiring terminal apparatus of the present information;

FIG. 10 is a flowchart for explaining an example of control operation in a management information acquiring routine executed as a management information acquiring process of FIG. 9;

FIG. 11 is a flowchart for explaining an example of control operation in an acquisition subject determining routine executed as an acquisition subject determining process of FIG. 9;

FIG. 12 is a flowchart for explaining an example of control operation in a download charge amount calculating routine executed as a download charge amount calculating process of FIG. 11;

FIG. 13 is a flowchart for explaining an example of control operation in an image acquiring routine executed as an image acquiring process of FIG. 9;

FIG. 14 is a block diagram for explaining an example of a configuration of the information acquiring terminal apparatus of FIG. 1 according to a second embodiment of the present invention and a schematic of functions of a control portion incorporated in the information acquiring terminal apparatus, and is a diagram corresponding to the diagram of FIG. 2;

FIG. 15 is a block diagram for explaining an example of a configuration of a management information retaining terminal according to the second embodiment of the present invention and a schematic of functions of a control portion incorporated in the management information retaining terminal;

FIG. 16 is a flowchart for explaining an example of control operation by the image acquiring terminal and the management information retaining terminal as the management information acquiring process in the flowchart of FIG. 9 according to the second embodiment of the present invention; and

FIG. 17 is an explanatory diagram of another example of display made on the touch panel display of the information acquiring terminal when an attribute is set by an acquisition subject attribute setting portion, and is a diagram corresponding to the diagram of FIG. 3.

### DESCRIPTION OF THE PREFERRED EMBODIMENTS

A first embodiment of the present invention will now be described in detail with reference to the drawings.

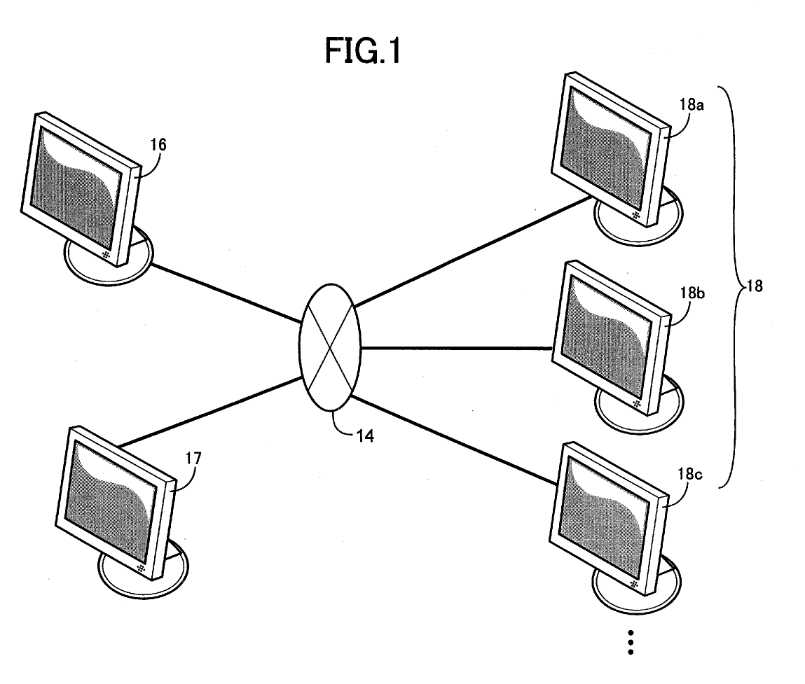

FIG. 1 depicts a working example of an information acquiring terminal apparatus 16 (also simply referred to as “information acquiring terminal 16”) according to a first embodiment of the present invention. As depicted in FIG. 1, the information acquiring terminal 16 is connected to a line 14 to be capable of information transmission/reception. The information acquiring terminal 16 is thus able to acquire management information on acquirable information, etc., from a management information retaining terminal apparatus 17 (also simply referred to as “management information retaining terminal 17”), which is another terminal also connected to the line 14 to be capable of information transmission/reception, via the line 14, and to acquire information retained by an information retaining terminal apparatus 18 (also simply referred to as “information retaining terminal 18”) also connected to the line 14 to be capable of information transmission/reception, from the information retaining terminal 18 based on the management information. While three information retaining terminals 18a, 18b, and 18c are depicted in FIG. 1, the information retaining terminal 18 is not limited in number, thus may be provided as a single terminal or a plurality of terminals. In this specification, the information retaining terminals 18a, 18b, and 18c are represented simply as information retaining terminal 18 when the information retaining terminals 18a, 18b, and 18c are not distinguished from each other. In the following embodiment, image data (image file) in a file format of image, etc., (e.g., JPEG (Joint Photographic Experts Group), PNG (Portable Network Graphics), and GIF (Graphics Interchange Format) is used as an equivalent to information of this embodiment. In this embodiment, therefore, information retained by the information retaining terminal 18 and acquired by the information acquiring terminal 16 is an image, but the present invention is not limited by this definition.

The line 14 is the line that charges on the basis of a given charge system based on at least one of a communication time and a communication distance. For example, the public telephone line is equivalent to such a line. On the telephone line, a communication charge (call charge) is levied based on a given charge system depending on the area codes of telephone numbers for a call origin and a call destination, i.e., the distance between an area the call origin belongs to and an area the call destination belongs to and with a communication time. Specifically, for example, the given charge system works in such a way that 8.5 yen is charged for a 3 minutes local call and 84 yen for a 3 minutes long-distance call made across a distance of over 100 km.

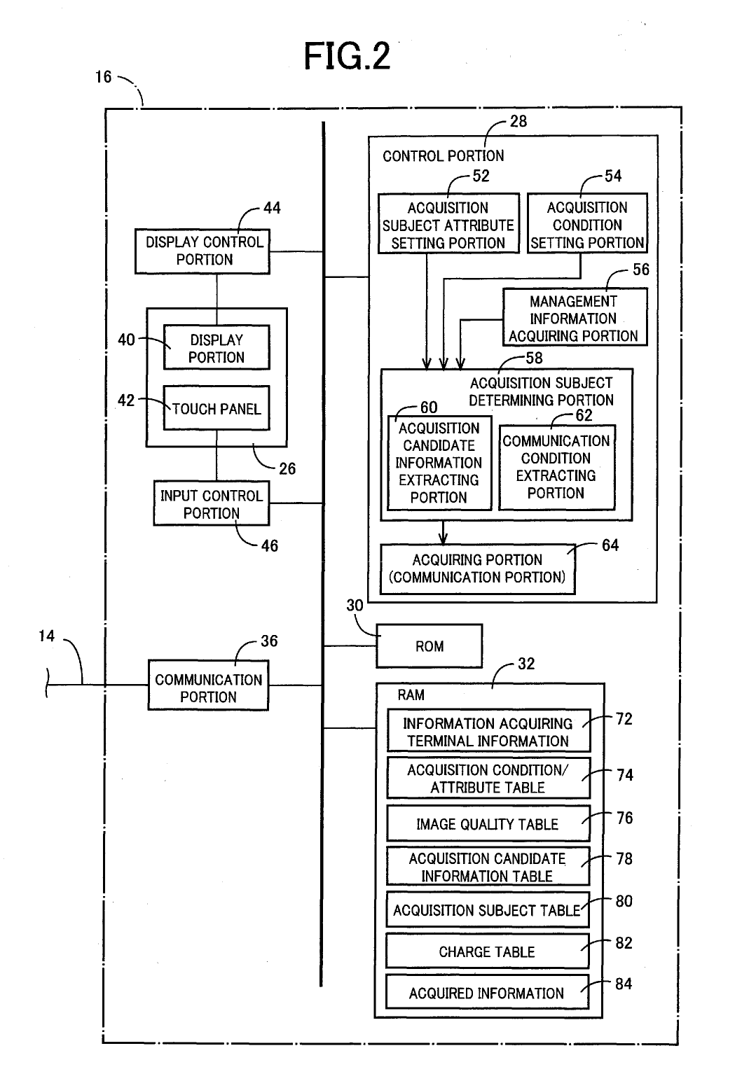

As depicted in FIG. 2, the information acquiring terminal 16 includes a touch panel display 26 that displays a given image and that makes input in response to touch operation by a user, a control portion 28 that carries out various controls including image display control by the information acquiring terminal 16, a ROM 30 serving as a read-only memory, a RAM 32 serving as a random read/write memory, and a communication portion 36 for carrying out telephone communication (call) with the management information retaining terminal 17 and with the information retaining terminal 18 via the line 14.

As depicted in FIG. 2, the touch panel display 26 has a display device 40 serving as a display portion that displays a given image on the touch panel display 26 and a touch panel 42 that makes input when the touch panel display 26 is touched by the user's finger, an accessory pen (not depicted), etc. The information acquiring terminal 16 also includes a display control portion 44 that controls display of an image (moving images) by the display device 40 and an input control portion 46 that processes input information entered on the touch panel 42. With the display control portion 44 and the input control portion 46, the touch panel display 26 carries out image display control and information input control via the display device 40 and the touch panel 42.

The control portion 28 is a so-called microcomputer that causes a CPU or central processing unit to carry out various information processing, based on information stored in the ROM 30 while utilizing a temporary memory function of the RAM 32. The control portion 28 carries out various controls related to the operation of the information acquiring terminal 16 of this embodiment, such as image display control of causing the touch panel display 26 (display device 40) to display a given image via the display control portion 44, input processing control of processing an input signal that is entered via the input control portion 46 in response to touch operation on the touch panel display 26 (touch panel 42), and communication control of controlling communication with the management information retaining terminal 17 and with the information retaining terminal 18 via the communication portion 36 and the line 14. To carry out such controls, the control portion 28 has such control functions as an acquisition subject attribute setting portion 52, an acquisition condition setting portion 54, a management information acquiring portion 56, an acquisition subject determining portion 58, and an acquiring portion 64. These control functions will be described later.

The RAM 32 has stored therein information acquiring terminal information 72, an acquisition condition/attribute table 74, an image quality table 76, an acquisition candidate information table 78, an acquisition subject table 80, a charge table 82, acquired information 84, etc. The information acquiring terminal information 72 is required when the information acquiring terminal 16 communicates with the management information retaining terminal 17 and with the information retaining terminal 18 via the line 14. For example, the information acquiring terminal information 72 is information on a telephone number, etc., on the line 14 to which the image acquiring terminal 16 is connected. The acquisition condition/attribute table 74 is the table having stored therein the attribute of information to acquire and acquisition conditions at information acquisition that are set by the acquisition subject attribute setting portion 52 and the acquisition condition setting portion 54 respectively. The image quality table 76 is the table that expresses acquisition conditions displayed in an classified form on the acquisition condition/attribute table 74, as specific numerical index ranges. The image quality table 76 of this embodiment represents an instance in which an acquisition condition is an image quality that is the properties of information. The acquisition candidate information table 78 is the table having stored therein acquirable information acquired by the management information acquiring portion 56 and information related to the acquired information. With the acquisition candidate information table 78, candidates matching acquisition conditions and an acquisition subject attribute are narrowed down to determine acquisition subject information. The acquisition subject table 80 is the table having stored therein at least a list of information that is determined by the acquisition subject determining portion 58 to be information to be actually acquired from the information retaining terminal 18. The charge table 82 is the table having stored therein the given charge system for charging for a telephone call made via the line 14. On the charge table 82, which is not depicted, for example, a charge amount is determined based on a communication time and a communication distance. The acquired information 84 is information itself that is acquired from the information retaining terminal 18 by the acquiring portion 64.

The functions of the control portion 28 will hereinafter be described based on the description of FIG. 2. The acquisition subject attribute setting portion 52 sets the attribute of information to acquire. In this embodiment, specifically, because information acquired by the information acquiring terminal 16 is an image, the attribute is equivalent to a keyword that is associated with the image as a place of photographing the image or the contents of the image. The attribute is entered by the user through the touch panel 42, etc. Control operation by the acquisition subject attribute setting portion 52 corresponds to an acquisition subject attribute setting step.

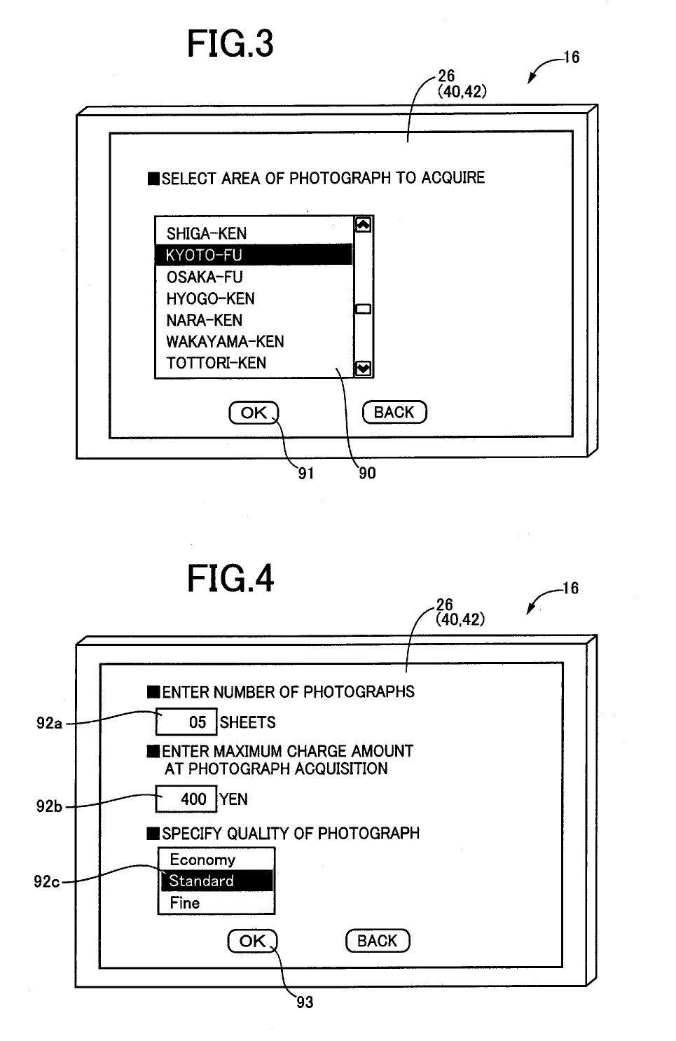

FIG. 3 depicts an instance in which attributes are area names represented as prefectural names. The display device 40 of the touch panel display 26 has an input space 90 displaying a list of selectable prefectural names as attribute candidates. When the user is to acquire an image related to Kyoto prefecture, the user touches a part of the touch panel display 26 that displays “Kyoto-fu” with the user's finger tip or an input touch pen. This causes the touch panel 42 to input selection of the display “Kyoto-fu”, thereby puts the display “Kyoto-fu” in a highlighted state on the display device 40. Subsequently, by touching an OK button 91 with the finger tip or touch pen, the whole input operation is completed. Hence the acquisition subject attribute setting portion 52 sets “Kyoto-fu” as the attribute of information to acquire.

In FIG. 2, the acquisition condition setting portion 54 sets acquisition conditions that are conditions at acquisition of information, i.e., an image. The acquisition conditions include a condition on a charge amount for communication made via the line 14 upon image acquisition, specifically, for example, include a maximum charge amount, and also include the number of images (pieces of picture) to acquire and the properties of images to acquire. Control operation by the acquisition condition setting portion 54 corresponds to an acquisition condition setting step.

As depicted in FIG. 4, the display device 40 of the touch panel display 26 has input spaces 92a and 92b for inputting the number of images and a maximum charge amount as acquisition conditions, respectively, and a selection space 92c for selectively inputting an image quality as image properties. The user inputs the desired number of images and the maximum charge amount to the input spaces 92a and 92b, respectively. This input operation is carried out by, for example, written character recognition on the touch panel 42 or use of a keyboard, etc., displayed on the touch panel display 26. A desired image quality is selected from the selection space 92c. This image quality selection is carried out in the same manner as attribute selection of FIG. 3. When an OK button 93 is touched with the finger tip or touch pen, the whole input operation is completed. Hence the acquisition condition setting portion 54 sets acquisition conditions depending on input contents. In the example of FIG. 4, 5 is entered as the number of images, 400 is entered as the maximum charge amount, and Standard is selected as the image quality.

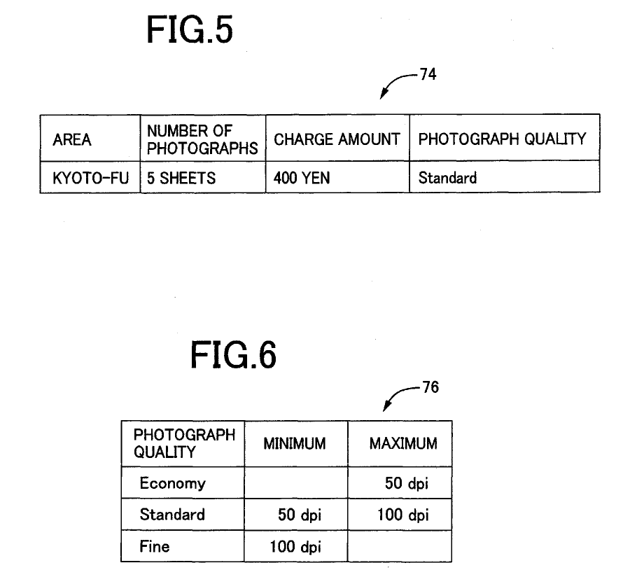

The acquisition condition/attribute table 74 depicted in FIG. 5 is stored in the RAM 32, as described above. On the acquisition condition/attribute table 74 of this embodiment, the area as the attribute set by the acquisition subject attribute setting portion 52 is recorded as “Kyoto-fu”, and the number of images, the maximum charge amount, and the image quality as the acquisition conditions set by the acquisition condition setting portion 54 are recorded as “5”, “400”, and “Standard”, respectively.

In this embodiment, as described referring to FIG. 4, image quality representing the properties of information is classified into three categories of “Economy”, “Standard”, and “Fine”, from which one category of image quality is selected. In this case, each of the categories “Economy”, “Standard”, and “Fine” is defined by a specific resolution, the number of colors, etc. The image quality table 76 depicted in FIG. 6 is stored in the RAM 32. On the image quality table 76 of FIG. 6, classified three categories of image quality are defined by, for example, image resolutions in dpi (dot per inch) units.

In FIG. 2, the management information acquiring portion 56 acquires management information on acquirable information. In this embodiment, management information includes an ID for an image as acquirable information, i.e., image ID, a file name, an area as an attribute, a file size (photograph size), resolution, information on a method of connection to the information retaining terminal 18 retaining the image, that is, specifically, information on a telephone number for the information retaining terminal 18, and a thumbnail image. In other words, this management information is the information indicating what image each information retaining terminal 18 retains. The management information acquiring portion 56 sends a management information acquisition request to the management information retaining terminal 17 via the line 14, and receives management information sent back from the management information retaining terminal 17 in response to the acquisition request to store the received management information temporarily in the RAM 32. In this embodiment, management information is accumulated in the management information retaining terminal 17. Preferably, the management information retaining terminal 17 may send an inquiry to each information retaining terminal 18 about its retained information, for example, at predetermined intervals to update management information retained by the management information retaining terminal 17.

The acquisition subject determining portion 58 determines acquisition subject information from management information acquired by the management information acquiring portion 56, based on an attribute set by the acquisition subject attribute setting portion 52 and acquisition conditions set by the acquisition condition setting portion 54. Specifically, the acquisition subject determining portion 58 extracts a combination of images satisfying the attribute and the acquisition conditions from images included in the management information, and determines the extracted images to be acquisition subject images. The acquisition subject determining portion 58 has functional elements of an acquisition candidate information extracting portion 60 and a communication condition calculating portion 62. Control operation by the acquisition subject determining portion 58 corresponds to an acquisition subject determining step.

The acquisition candidate information extracting portion 60 extracts an image whose attribute matches the attribute set by the acquisition subject attribute setting portion 52 from acquirable images in the management information acquired by the management information acquiring portion 56, as acquisition candidate information. In this embodiment, the area as the attribute is “Kyoto-fu”, so that an image whose attribute matches the attribute “Kyoto-fu” in the management information is extracted as acquisition candidate information. Not only the acquirable image in the management information that has the attribute matching the attribute set by the acquisition subject attribute setting portion 52, but an image whose attribute is similar to the set attribute at a predetermined given similarity level may also be extracted as acquisition candidate information.

The communication condition calculating portion 62 calculates a communication condition for each acquisition candidate information extracted by the acquisition candidate information extracting portion 60, for a case where the information acquiring terminal 16 acquires each acquisition candidate information from the information retaining terminal 18 retaining the acquisition candidate information via the line 14. The communication condition includes a charge amount levied at acquisition of each acquisition candidate information, and, in this embodiment, the charge amount is used as the communication condition. Specifically, the communication condition calculating portion 62 calculates a charge amount depending on a communication time and a communication distance, referring to the charge table 82 stored in the RAM 32, for each acquisition candidate information. The communication time is calculated from a transmission time, which is computed from the file size of each acquisition candidate information included in the management information and the known transmission rate of the communication portion 36 (e.g., 56 kbps), and a known negotiation time required by the communication portion 36 for negotiation. The communication distance is determined by applying the area code of the telephone number for the information acquiring terminal 16, the telephone number being the information acquiring terminal information 72 stored in the RAM 32, and the area code of the telephone number for each information retaining terminal 18 retaining each acquisition candidate information included in the management information, to the charge table 82. In this manner, the communication condition calculating portion 62 calculates a charge amount at information acquisition for each acquisition candidate information that is extracted by the acquisition candidate information extracting portion 60 as information to acquire whose attribute matches the set attribute.

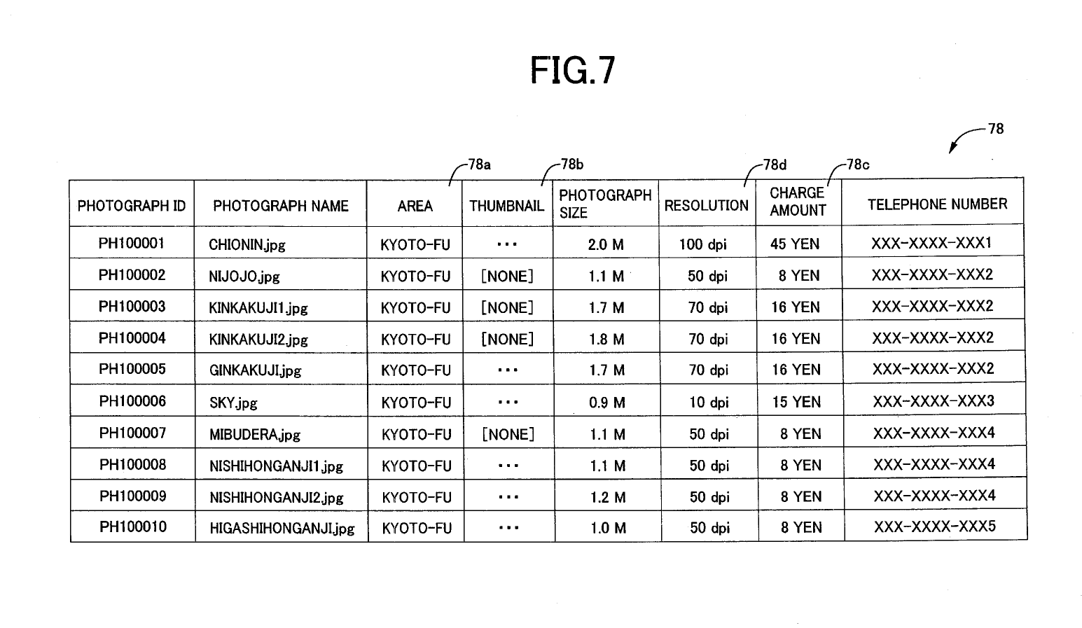

The acquisition candidate information table 78 depicted in FIG. 7 is stored in the RAM 32. The acquisition candidate information table 78 has stored therein pieces of information included in management information, such as image IDs that are IDs for acquirable images, file names, areas as attributes, file sizes (photograph sizes), resolution, information on a method of connection to the information retaining terminals 18 retaining the images, that is, specifically, information of telephone numbers for the information retaining terminals 18, and thumbnail images. For an image not including a thumbnail image, not “thumbnail image” but “none” is entered in a thumbnail space 78b to indicate the absence of a thumbnail image.

In this embodiment, as stated above, the acquisition candidate information extracting portion 60 extracts an image to acquire having an attribute of “Kyoto-fu”. The acquisition candidate information table 78 of FIG. 7, therefore, does not include an image having an attribute not entered as “Kyoto-fu” in an attribute space 78a. The acquisition candidate information table 78 of FIG. 7 is provided with an amount space 78c, in addition to spaces for management information on each image, and a charge amount as a communication condition that is calculated by the communication condition calculating portion 62 is entered in the amount space 78c.

The acquisition subject determining portion 58 determines a combination of images satisfying acquisition conditions set by the acquisition condition setting portion 54 to be acquisition subject images, referring to the acquisition candidate information table 78 of FIG. 7. Specifically, in this embodiment, acquisition conditions are stored in the acquisition condition/attribute table of FIG. 5. The acquisition subject determining portion 58 thus determines a combination of images satisfying acquisition conditions of an image quality of “Standard”, the number of images of 5, and being acquirable within a charge amount range of 400 yen to be acquisition subject images, referring to the acquisition candidate information table 78 of FIG. 7. The determined combination of images are stored in the acquisition subject table 80.

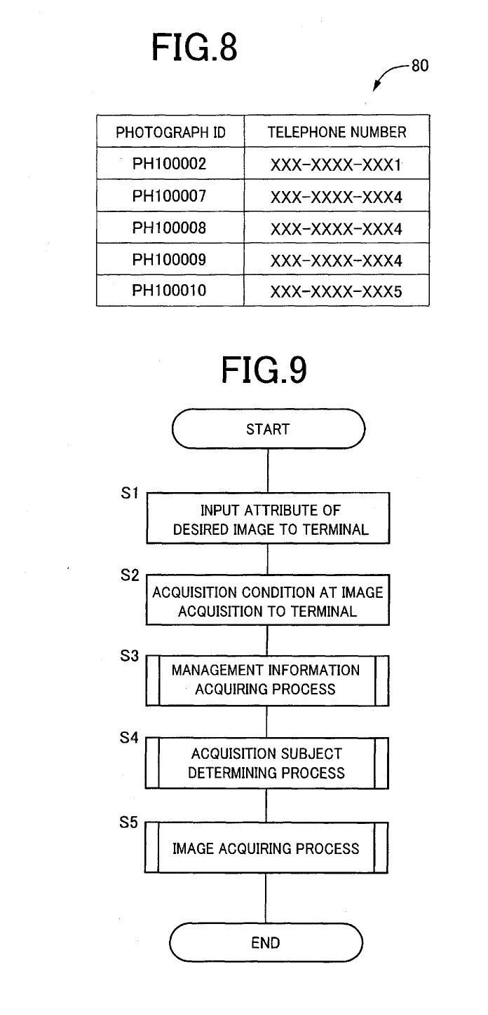

The acquisition subject table 80 of FIG. 8 is stored in the RAM 32. In this embodiment, the acquisition information determining portion 58 determines 5 images with photograph IDs of “PH100002”, “PH100007”, “PH100008”, “PH100009”, and “PH1000010” to be acquisition information. The acquisition subject table 80 of FIG. 8 has stored therein not only image IDs for acquisition subject images but also telephone numbers for information retaining terminals 18 retaining the images. These telephone numbers are extracted from the acquisition candidate information table 78, temporarily stored management information, etc.

The acquiring portion 64 receives an image determined to be an acquisition subject image by the acquisition subject determining portion 58, from the information retaining terminal 18 retaining the image via the line 14. Specifically, for example, to acquire each image corresponding to each image ID stored in the acquisition subject table 80 of FIG. 8, the acquiring portion 64 makes a telephone call to the information retaining terminal 18 retaining the image corresponding to the image ID by entering the telephone number of the information retaining terminal 18. The acquiring portion 64 then sends a request for transmission of the image corresponding to the image ID to the information retaining terminal 18 connected to the acquiring portion 64 via the line 14 that is the telephone line, and receives the incoming image transmitted from the information retaining terminal 18. The received image is stored in the RAM 32 as the acquired information 84. This process is repeated on each acquisition subject image to complete acquisition of acquisition subject images. Control operation by the acquiring portion 64 corresponds to an acquiring step.

In this embodiment, a configuration of the management information retaining terminal 17 is not particularly specified when the management information retaining terminal 17 is capable of storing management information and transmitting the management information to the information acquiring terminal 16 via the line 14 in response to a request from the information acquiring terminal 16. Likewise, a configuration of the information retaining terminal 18 is not particularly specified when the information retaining terminal 18 is capable of storing information and transmitting the information to the information acquiring terminal 16 via the line 14 in response to a request from the information acquiring terminal 16.

A schematic of the control operation by the information acquiring terminal apparatus 16 of this embodiment will be described referring to FIG. 9. At step S1 corresponding to the acquisition subject attribute setting portion 52 (hereinafter, “step” will be omitted), the CPU sets the attribute of an image to acquire (desired image). This setting is carried out by, for example, receiving input by a user on the touch panel 26.

At S2 corresponding to the acquisition condition setting portion 54, the CPU sets acquisition conditions at image acquisition. These acquisition conditions include a condition on a maximum charge amount in communication carried out via the line upon acquiring an image. This acquisition condition setting is carried out by, for example, receiving input by the user on the touch panel 26.

At S3 corresponding to the management information acquiring portion 56 and the acquisition candidate information extracting portion 60 of the acquisition subject determining portion 58, the CPU executes a management information acquiring routine for acquiring management information retained by the management information retaining terminal 17 via the line 14. This management information includes information of an image that is information acquirable via the line 14, such as an image ID that is an ID for the image, a file name, an area as an attribute, a file size (photograph size), resolution, information on a method of connection to the information retaining terminal 18 retaining the image, that is, specifically, information of a telephone number for the information retaining terminal 18, and a thumbnail image. The acquired management information is saved in the RAM 32, etc., of the information acquiring terminal 16.

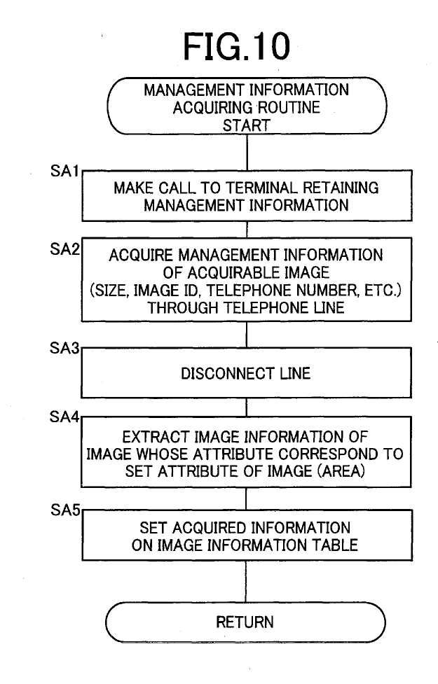

An example of control operation in the management information acquiring routine will be described referring to FIG. 10. At SA1, the CPU establishes communication between the communication portion 36 of the information acquiring terminal 16 and the management information retaining terminal 17 via the line 14. Specifically, since the line 14 is the public telephone line in this embodiment, a call is made to the management information retaining terminal 17 by entering its telephone number to put the information acquiring terminal 16 and the management information retaining terminal 17 in a state where they are able to transmit/receive information to/from each other.

At SA2, the CPU acquires management information of an image that is information acquirable via the line 14, using the line 14 used at SA1. When transmission of the management information from the management information retaining terminal 17 to the information acquiring terminal 16 is completed, SA3 follows, at which the CPU disconnects the line 14 establishing connection between the management information retaining terminal 17 and the information acquiring terminal 16. In the management information acquiring routine of FIG. 10, SA1 and SA3 correspond to the management information acquiring portion 56.

At SA4, the CPU carries out image extraction from the management information acquired at SA2, based on the attribute of the image set at S1 of FIG. 9, i.e., contents stored in the acquisition condition/attribute table 74. Specifically, the CPU carries out work of extracting only the acquirable image included in the management information acquired at SA2 that has an attribute matching or similar at a given similarity level to the attribute of the image set at S1. Because the attribute of an image is a prefectural name representing a place of photographing, etc., in this embodiment, being similar in attribute at a given similarity level portion, for example, an instance of inclusion of the name of a prefecture neighboring the attribute prefecture or a prefecture belonging to the same region the attribute prefecture belongs to. When a general name is used as an attribute, wavering in expression or another name representing the same concept is included as similarity in attribute. At step SA4, an image extracted from the management information is acquisition candidate information.

At SA5, the CPU stores the management information extracted at SA4 in the acquisition candidate information table 78. In the management information acquiring routine of FIG. 10, SA4 and SA5 correspond to the acquisition candidate information extracting portion 60 of the acquisition subject determining portion 58.

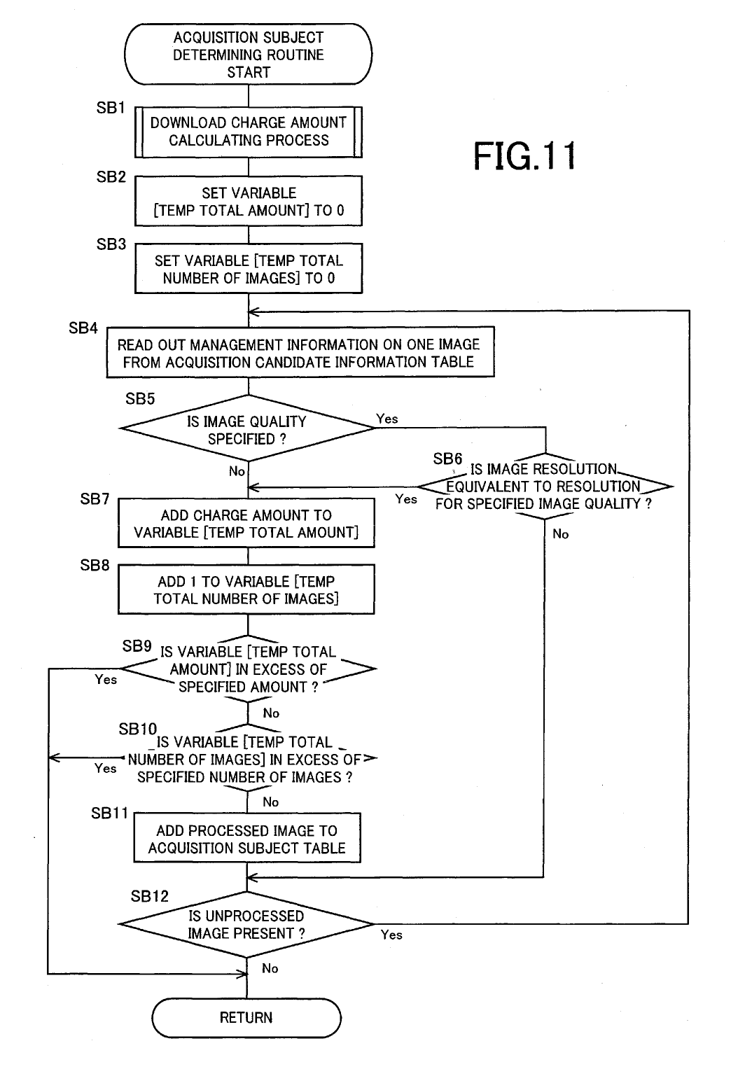

In FIG. 9, at S4 corresponding to the acquisition subject determining portion 58, the CPU executes an acquisition subject determining routine for determining an acquisition subject image. FIG. 11 is a flowchart for explaining an example of control operation in the acquisition subject determining routine.

At SB1, the CPU executes a download charge amount (charge amount) calculating routine. In the download charge amount (charge amount) calculating routine, a communication condition for each image extracted at SA4 and stored in the acquisition candidate information table 78 at SA5 is calculated for a case where the information acquiring terminal 16 acquires each image from the information retaining terminal 18 retaining the image via the line 14.

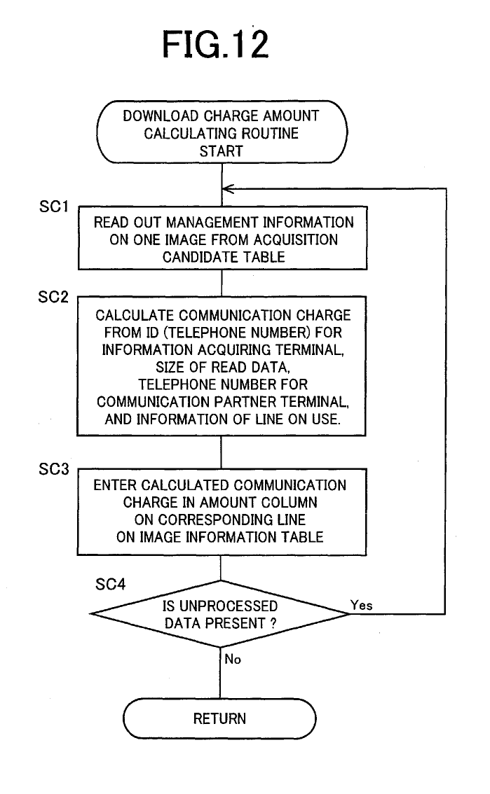

An example of control operation in the download charge amount calculating routine will be described referring to FIG. 12. This control operation corresponds to the communication condition calculating portion 62 of the acquisition subject determining portion 58. At SC1, the CPU reads in management information on one image from the acquisition candidate information table 78.

At SC2, the CPU calculates a charge amount (communication charge) for communication at acquisition of the image corresponding to the management information read in at SC1, based on the management information read in at SC1 and the information acquiring terminal information 72 stored in advance. Specifically, based on the area codes of the telephone numbers for the information retaining terminal 18 retaining the image and the information acquiring terminal 16, a charge system applied to communication between both terminals 18 and 16 via the line 14 is selected from the charge table 82. Based on a time required for transmission/reception that is calculated from a prestored communication rate in communication between both terminals 18 and 16 via the line 14 and the file size of the image and on an experimentally precalculated time required for such communication preparation as negotiation between both terminals 18 and 16 via the line 14, a communication time between the point of connection and the point of disconnection of the line 14 is calculated. Hence a charge amount corresponding to the communication time is calculated based on the selected charge system.

At SC3, the CPU enters the charge amount as an acquisition condition calculated at SC2 in the amount space 78c on the acquisition candidate information table 78.

At SC4, the CPU determines whether an image not subjected to the processes at SC1 to SC3 is present among images stored in the acquisition candidate information table 78. When the processes at SC1 to SC3 are carried out on not all of images stored in the acquisition candidate information table 78, the determination at step SC4 gives a conclusion YES. As a result, the processes at SC1 to SC3 are carried out on an image not subjected to the processes at SC1 to SC3 yet. When the processes at SC1 to SC3 are carried out on all of the images stored in the acquisition candidate information table 78, the determination at step SC4 gives a conclusion NO, in which case the routine comes to an end.

In FIG. 11, at SB2, the CPU initializes a variable “TEMP total amount” representing a total charge amount in the acquisition subject determining routine to set the variable to 0. At SB3, the CPU initializes a variable “TEMP total number of images” representing the number of images (number of files) to acquire in the routine to set the variable to 0.

At SB4, the CPU reads out management information on one image from the acquisition candidate information table 78.

At SB5, the CPU determines whether a condition on the image quality of the image is specified as an acquisition condition at image acquisition, referring to the acquisition condition/attribute table 74. When the image quality is specified as the acquisition condition, that is, when the condition on the image quality is stored in the acquisition condition/attribute table 74, the determination at step SB5 gives a conclusion YES, in which case SB6 is carried out. When the image quality is not specified as the acquisition condition, SB7 is carried out.

At SB6, the CPU determines whether an image quality stored in the management information on the image read at SB4 satisfies the specified condition on the image quality. In this determination, for example, to which of three categories of image quality stored in the image quality table 76 the image quality is equivalent is determined based on the resolution entered in the resolution space 78d of the acquisition candidate information table 78, and then whether the determined image quality matches an image quality stored in the acquisition condition/attribute table 74 is determined. When the image quality stored in the management information on the image read at SB4 satisfies the specified condition on the image quality, the determination at step SB6 gives a conclusion YES, in which case SB7 is carried out. When the image quality stored in the management information on the image read at SB4 does not satisfy the specified condition on the image quality, the determination at step SB6 gives a conclusion NO, in which case the image corresponding to the management information read at SB4 is not determined to be an acquisition subject image. As a result, SB12 is carried out.

At SB7, the CPU adds a charge amount entered in the amount space 78c (see FIG. 7), which is included in the management information read at SB4, to the variable “TEMP total amount”. At SB8, 1 is added to the variable “TEMP total number of images”. These processes correspond to calculation of a total charge amount and the total number of images to acquire in a case when acquiring images which corresponds to the management information read at SB4.

At SB9, the CPU determines whether the variable “TEMP total amount” exceeds a maximum charge amount (specified amount) set as an acquisition condition. The maximum charge amount is stored, for example, in the acquisition condition/attribute table 74, thus acquired by referring thereto. When the variable “TEMP total amount” exceeds the maximum charge amount, the determination at step SB9 gives a conclusion YES, in which case the image of which the management information is read at SB4 is not added to acquisition subject images, and the flowchart comes to an end.

At SB10, the CPU determines whether the variable “TEMP total number of images” exceeds the number of images to acquire set as an acquisition condition. The number of images to acquire is stored, for example, in the acquisition condition/attribute table 74, thus acquired by referring thereto. When the variable “TEMP total number of images” exceeds the number of images to acquire, the determination at step SB10 gives a conclusion YES, in which case the image of which the management information is read at SB4 is not added to acquisition subject images, and the flowchart comes to an end.

At SB11, the CPU adds the image of which the management information is read at SB4 to acquisition subject images. Specifically, in this embodiment, for the image of which the management information is read at SB4, the image ID and a telephone number for the information retaining terminal 18 retaining the image are stored in the acquisition subject table 80.

At SB12, the CPU determines whether an image not subjected to the processes at SB4 to SB11 is present among images stored in the acquisition candidate information table 78. When the image not subjected to the processes at SB4 to SB11 is present among the images stored in the acquisition candidate information table 78, the determination at step SB12 gives a conclusion YES, in which case the processes are carried out on the image not subjected to the processes at SB4 to SB11 yet. When all of the images stored in the acquisition candidate information table 78 are subjected to the processes at SB4 to SB11, the determination at step SB12 gives a conclusion NO, in which case the routine comes to an end.

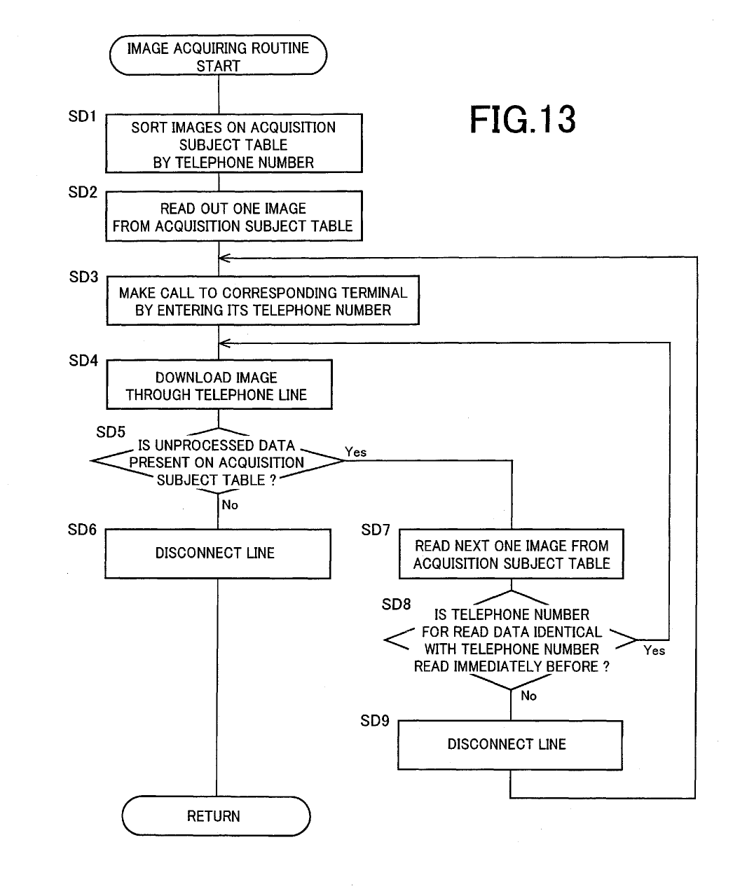

In FIG. 9, at S5 corresponding to the acquiring portion 64, the CPU carries out an image acquiring routine for acquiring an acquisition subject image. FIG. 13 is a flowchart for explaining an example of control operation in the image acquiring routine.

At SD1, the CPU sorts images on the acquisition subject table 80, which is a list of acquisition subject images made in the acquisition subject determining routine of FIG. 12, by telephone numbers for the information retaining terminals 18 retaining the images. This allows acquisition of a plurality of images through one time of connection of the line 14 in the case of acquiring a plurality of images from the same information retaining terminal 18, which will be described later, thus enables a charge amount reduction in the case of charging for each line connection.

At SD2, when one image is selected from the acquisition subject table 80, the CPU reads in an image ID for the image and a telephone number for the information retaining terminal 18 retaining the image. At SD3, the CPU establishes communication between the communication portion 36 of the information acquiring terminal 16 and the information retaining terminal 18 via the line 14. Specifically, a call is made by entering the telephone number read at SD2, which puts the information acquiring terminal 16 and the information retaining terminal 18 in a state where they are able to transmit/receive information to/from each other via the line 14 that is the public telephone line.

At SD4, the CPU causes the information acquiring terminal 16 to acquire the image with the image ID read at SD2 from the information retaining terminal 18. Specifically, for example, the information acquiring terminal 16 sends an image transmission request to the information retaining terminal 18, using the image ID read at SD2, and the information retaining terminal 18 transmits the requested image to the information acquiring terminal 16 in response to the transmission request. The image acquired at step SD4 is stored in the RAM 32, etc., of the information acquiring terminal 16 as the acquired information 84.

At SD5, the CPU determines whether an image not subjected to the acquiring process at SD3 and SD4 is present among images stored in the acquisition subject table 80. When the image not subjected to the acquiring process at SD3 to SD4 is present among the images stored in the acquisition subject table 80, the determination at step SD5 gives a conclusion YES, in which case SD7 and the ensuing steps are carried out. When all of the images stored in the acquisition subject table 80 have been subjected to the acquiring process at SD3 and SD4, the determination at step SD5 gives a conclusion NO, in which case SD6 is carried out.

At SD6 that is carried out when the determination at SD5 gives a conclusion NO, the CPU disconnects the line 14, which is connected at SD3, and then ends the routine.

At SD7 that is carried out when the determination at SD5 gives a conclusion YES, the CPU selects another image not subjected to the process at SD3 and SD4 yet from the acquisition subject table, and reads in an image ID for the image and a telephone number for the information retaining terminal 18 retaining the image.

At SD8, the CPU determines whether the telephone number read at SD7 is identical with a telephone number read immediately before, i.e., a telephone number for a connection destination currently connected via the line 14. When the telephone number read at SD7 is identical with the telephone number for the current connection destination, the determination at step SD8 gives a conclusion YES, in which case SD4 is carried out to acquire the image selected at SD7. When a plurality of images are acquired from the information retaining terminal 18 that is the same connection destination, therefore, the line 14 as established connection is not disconnected, so that no reconnection of the line 14 occurs. When the telephone number read at SD7 is not identical with the telephone number for the current connection destination, the determination at step SD8 gives a conclusion NO, in which case SD9 is carried out.

At SD9, the CPU disconnects the connected line 14. Following disconnection of the line 14, SD3 is carried out to establish connection to the information retaining terminal 18 with the telephone number read at SD7, which is a connection destination different from the previous connection destination.

According to the embodiment, when an image is acquired through the line 14 that charges on the basis of a given charge system based on at least one of a communication distance and a communication time, the acquisition subject attribute setting portion 52 sets the attribute of the image to acquire depending on input by the user, and the acquisition condition setting portion 54 sets acquisition conditions including a maximum charge amount at image acquisition depending on input by the user. Based on a charge amount as a communication condition in the case of acquiring each acquisition candidate information matching the attribute set by the acquisition subject attribute setting portion 52, the acquisition subject determining portion 58 determines the acquisition candidate information satisfying the acquisition condition to be an acquisition subject image. The acquiring portion 64 acquires the acquisition subject image through the line 14. This allows acquisition of the image satisfying the attribute as well as the acquisition conditions including the maximum charge amount.

According to the embodiment, the communication conditions include a charge amount that is calculated on the basis of a given charge system stored in the charge table 82 that is based on at least one of a communication distance in communication for acquiring acquisition candidate information and a communication time calculated from a communication rate and the size of the acquisition candidate information. Based on whether a charge amount in communication for acquiring each acquisition candidate information satisfies a condition on the maximum charge amount included in the acquisition conditions, therefore, the acquisition subject determining portion 58 determines whether or not to determine the acquisition candidate information to be an acquisition subject image. This allows acquisition of the image satisfying the attribute as well as the acquisition conditions including the maximum charge amount.

According to the embodiment, the acquisition conditions determined by the acquisition condition setting portion 54 include at least one of the number of information files, i.e., number of images, and an image quality as information properties. This allows acquisition of the image that satisfies the attribute as well as the acquisition conditions including at least one of the number of images and the image quality in addition to the maximum charge amount.

According to the embodiment, an attribute set by the acquisition subject attribute setting portion 52 is a place name that is associated information associated in advance with an image. This allows acquisition of the image that satisfies the attribute as a place name associated in advance with the image as well as the acquisition conditions including the maximum charge amount in image acquisition.

According to the embodiment, the acquisition subject determining portion 58 has the acquisition candidate information extracting portion 60 that extracts an image whose attribute matches an attribute set by the acquisition subject attribute setting portion 52 from acquirable images stored in advance, as acquisition candidate information, and a communication condition calculating portion 62 that calculates a communication condition including a charge amount in the case of acquiring each acquisition candidate information based on a given charge system stored in advance. This allows acquisition of the image that satisfies the attribute associated in advance with the image as well as the acquisition conditions including the maximum charge amount, based on management information that is a list of acquirable images stored in the information acquiring terminal apparatus 16 and on the given charge system stored as the charge table 82.

A second embodiment of the present invention will then be described. In the following description, the portion common to both first and second embodiments will be denoted by the same reference numeral and omitted in further explanation.

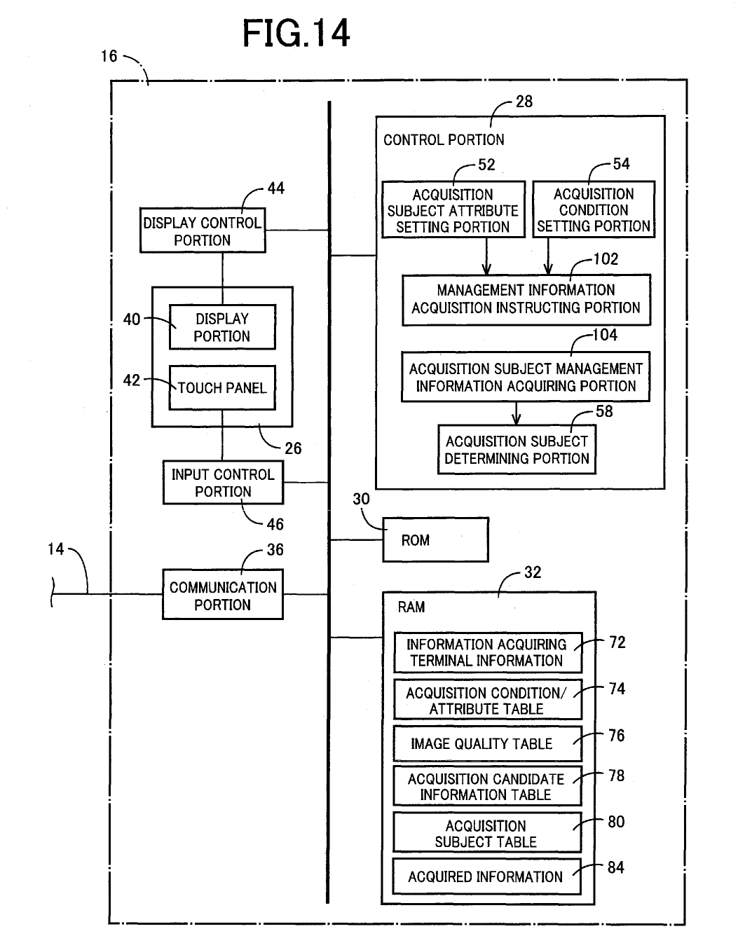

FIG. 14 corresponds to FIG. 2 of the first embodiment. Comparing FIG. 2 with FIG. 14 reveals a difference that the information acquiring terminal 16 of this embodiment does not include the charge information calculating portion 56 and the acquisition subject determining portion 58 but includes a management information acquisition instructing portion 102 and an acquisition subject management information acquiring portion 104.

The management information acquisition instructing portion 102 transmits the attribute of an image to acquire set by the acquisition subject attribute setting portion 52 and acquisition conditions set by the acquisition condition setting portion 54 to the management information retaining terminal 17, which will be described later. The management information acquisition instructing portion 102 then instructs the management information retaining terminal 17 to transmit management information on an image satisfying the attribute and acquisition conditions among images acquirable via the line 14, i.e., acquisition subject management information back to the information acquiring terminal 16. In this process, information required by an acquisition subject determining portion 122 of the management information retaining terminal 17 to be described later, such as a telephone number for the information acquiring terminal 16 that is the information acquiring terminal information 72 stored in the RAM 32 of the information acquiring terminal 16, is also transmitted.

The acquisition subject management information acquiring portion 104 acquires the acquisition subject management information that is transmitted back from the management information retaining terminal 17 based on the instruction given to the management information retaining terminal 17 by the management information acquisition instructing portion 102. The acquired acquisition subject management information is saved in the acquisition candidate information table 78 of the RAM 32.

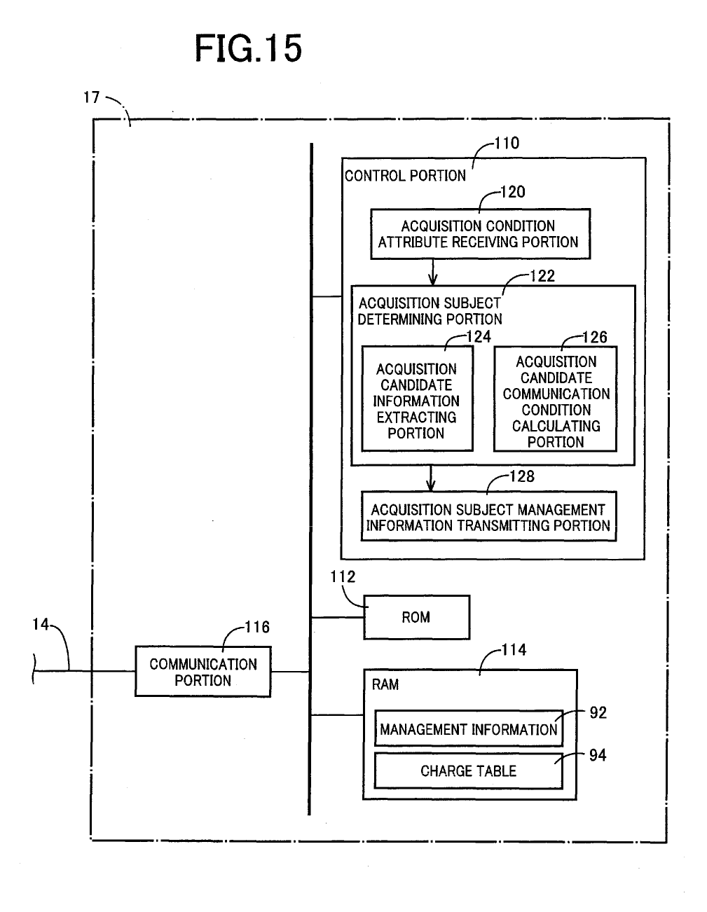

In the first embodiment, the management information retaining terminal 17 stores management information therein and is capable of transmitting the management information to the information acquiring terminal 16 via the line 14 in response to a transmission request from the information acquiring terminal 16. According to the second embodiment, in contrast, the management information retaining terminal 17 has such functions as described later, thus having a configuration, for example, as depicted in FIG. 15.

As depicted in FIG. 15, the management information retaining terminal 17 includes a control portion 110 that carries out various controls by the management information retaining terminal 17, a ROM 112 serving as a read-only memory, a RAM 114 serving as a random read/write memory, and a communication portion 116 for carrying out telephone communication (call) with the information acquiring terminal 16 or with the information retaining terminal 18 via the line 14.

Like the control portion 28 of the information acquiring terminal 16, the control portion 110 is a so-called microcomputer that causes a CPU or central processing unit to carry out various information processing, based on information stored in the ROM 112 while utilizing a temporary memory function of the RAM 114. The control portion 110 carries out various controls related to the operation of the management information retaining terminal 17 of this embodiment. To carry out such controls, the control portion 110 has such control functions as a communication condition/attribute receiving portion 120, an acquisition subject determining portion 122, and an acquisition subject management information transmitting portion 128. These control functions will be described later.

The RAM 114 has stored therein management information 92, a charge table 94, etc. The management information 92 is similar to the management information of the first embodiment, being the information on an image that is acquirable information. Specifically, the management information 92 includes an ID for an acquirable image, i.e., image ID, a file name, an area as an attribute, a file size (photograph size), resolution, information on a method of connection to the information retaining terminal 18 retaining the image, that is, specifically, information of a telephone number for the information retaining terminal 18, and a thumbnail image. The charge table 94 is the table having stored therein the given charge system that is applied when telephone communication is carried out via the line 14. With the charge table 94, which is not depicted, a charge amount can be determined based on, for example, a communication time and a communication distance. The charge table 94 is similar to the charge table 82 stored in the RAM 32 of the information acquiring terminal 16 of the first embodiment.

The functions of the control portion 110 will hereinafter be described referring to FIG. 15. The communication condition/attribute receiving portion 120 receives the attribute of an image to acquire set by the acquisition subject attribute setting portion 52 and acquisition conditions set by the acquisition condition setting portion 54. The received attribute and acquisition conditions are temporarily stored in the RAM 114, etc.

In the same manner as the acquisition subject determining portion 58 of the first embodiment does, the acquisition subject determining portion 122 determines acquisition subject information from the management information 92 stored in the RAM 114, based on the attribute and acquisition conditions received by acquisition condition/attribute receiving portion 120. Specifically, the acquisition subject determining portion 122 extracts a combination of images satisfying the attribute and acquisition conditions from images included in the management information 92, and determines the extracted images to be acquisition subject images. The acquisition subject determining portion 122 has functional elements of an acquisition candidate information extracting portion 124 and a communication condition calculating portion 126.

In the same manner as the acquisition candidate information extracting portion 60 of the first embodiment does, the acquisition candidate information extracting portion 124 extracts an image whose attribute matches the attribute set by the acquisition subject attribute setting portion 52 of the information acquiring terminal 16 and received by the acquisition condition/attribute receiving portion 120 from acquirable images in the management information 92, as acquisition candidate information. In the same manner as in the first embodiment, when an area as the attribute is “Kyoto-fu”, an image whose attribute matches the attribute “Kyoto-fu” in the management information is extracted as acquisition candidate information. Not only the acquirable image in the management information having the attribute matching the attribute set by the acquisition subject attribute setting portion 52 but an image having an attribute similar to the attribute set at a predetermined given similarity level may also be extracted as acquisition candidate information.

In the same manner as the communication condition calculating portion 62 of the first embodiment does, the communication condition calculating portion 126 calculates a communication condition for each acquisition candidate information extracted by the acquisition candidate information extracting portion 124, for a case where the information acquiring terminal 16 acquires each acquisition candidate information from the information retaining terminal 18 retaining the acquisition candidate information via the line 14. The communication condition includes a charge amount levied at acquisition of each acquisition candidate information, and, in this embodiment, the charge amount is used as the communication condition. Specifically, the communication condition calculating portion 126 calculates a charge amount depending on a communication time and a communication distance, referring to the charge table 94 stored in the RAM 114, for each acquisition candidate information. The communication time is calculated from a transmission time computed from the file size of each acquisition candidate information included in the management information and the known transmission rate of the communication portion 36 (e.g., 56 kbps) of the information acquiring terminal 16 and from a known negotiation time required by the communication portion 36 for negotiation. The communication distance is determined by applying the area code of the telephone number for the information acquiring terminal 16, which is the information acquiring terminal information 72 stored in the RAM 32 of the information acquiring terminal 16, and the area code of the telephone number for each information retaining terminal 18 retaining each acquisition candidate information included in the management information, to the charge table 94. In this manner, the communication condition calculating portion 126 calculates a charge amount levied at information acquisition for each acquisition candidate information that is extracted by the acquisition candidate information extracting portion 124 as information to acquire whose attribute matches the set attribute.

In this embodiment, for the management information 92 stored in the RAM 114, the acquisition candidate information table 78 is provided, for example, in such manner as depicted in FIG. 7 to indicate the management information given as a result of extraction of acquisition candidate information by the acquisition candidate information extracting portion 124 and calculation of a charge amount as a communication condition by the communication condition calculating portion 94. The acquisition candidate information table 78 made in this manner is stored temporarily in the RAM 114.

In the same manner as the acquisition subject determining portion 58 of the first embodiment does, the acquisition subject determining portion 122 determines a combination of images satisfying acquisition conditions set by the acquisition condition setting portion 54 of the information acquiring terminal 16 and received by the acquisition condition/attribute receiving portion 120 to be acquisition subject images, referring to the acquisition candidate information table 78 of FIG. 7. Specifically, in this embodiment, the case of acquisition conditions being stored in the acquisition condition/attribute table of FIG. 5 is considered, as in the first embodiment. The acquisition subject determining portion 122 thus determines a combination of images satisfying acquisition conditions of an image quality of “Standard”, the number of images of 5, and being acquirable within a charge amount range of 400 yen to be acquisition subject images, referring to the acquisition candidate information table 78 of FIG. 7. The determined combination of images are stored in the same manner as the acquisition subject table 80 of FIG. 8.

FIG. 8 depicts an example of the acquisition subject table indicating a list of images that are determined to be acquisition subject images by the acquisition subject determining portion 58. The acquisition subject table is stored temporarily in the RAM 114.

The acquisition subject management information transmitting portion 128 transmits the acquisition subject table for images determined to be acquisition subject images by the acquisition subject determining portion 122, to the information acquiring terminal 16.

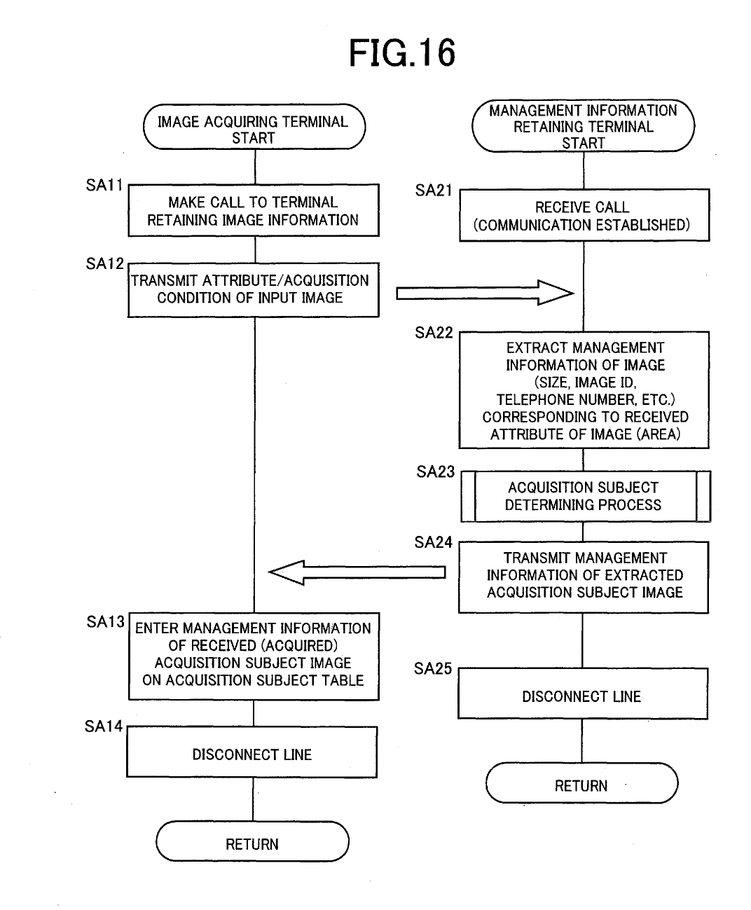

FIG. 16 is a flowchart for explaining an example of control operation carried out by the image acquiring terminal 16 and the management information retaining terminal 17 for determining an acquisition subject image in this embodiment. The flowchart of FIG. 16 is executed as a management information acquiring routine in place of the management information acquiring routine of FIG. 10 corresponding to S3 and S4 of the flowchart of FIG. 9 of the first embodiment.

At SA11 and SA21, the CPU of the information acquiring terminal 16 and that of the management information retaining terminal 17 establish communication between the communication portion 36 of the information acquiring terminal 16 and the management information retaining terminal 17 via the line 14. Specifically, since the line 14 is the public telephone line in this embodiment, a call is made to the management information retaining terminal 17 by entering its telephone number to put the information acquiring terminal 16 and the management information retaining terminal 17 in a state where they are able to transmit/receive information to/from each other.

At SA12 corresponding to the management information acquisition instructing portion 102 of the information acquiring terminal 16, the CPU of information acquiring terminal 16 transmits the attribute of an image to acquire and acquisition conditions that are set at SA1 and SA2 of FIG. 9, in which transmission the line 14 of which connection is established at SA1 is used. The attribute and acquisition conditions are received by the acquisition condition/attribute receiving portion 102 of the management information retaining terminal 17.

At SA22 corresponding to the acquisition candidate information extracting portion 124 of the acquisition subject determining portion 122, the CPU of the management information retaining terminal 17 carries out image extraction from the management information 92 stored in the RAM 114, etc., based on the attribute of the image transmitted at S12 and received by the management information retaining terminal 17, i.e., contents stored in the acquisition condition/attribute table 74. Specifically, the CPU carries out work of extracting only the acquirable image included in the management information 92 that has an attribute matching or similar at a given similarity level to the attribute of the image transmitted at S12 and received by the management information retaining terminal 17. Because the attribute of an image is a prefectural name representing a place of photographing, etc., in this embodiment, being similar in attribute at a given similarity level portion, for example, an instance of inclusion of the name of a prefecture neighboring the attribute prefecture or a prefecture belonging to the same region the attribute prefecture belongs to. When a general name is used as an attribute, wavering in expression or another name representing the same concept is included as similarity in attribute. Management information extracted at step SA22 is stored temporarily in the RAM 114, etc., as the acquisition candidate information table.

At SA23 corresponding to the communication condition calculating portion 126 of the acquisition subject determining portion 122, the CPU of the management information retaining terminal 17 executes an acquisition subject determining routine for determining an acquisition subject image. In this acquisition subject determining routine, the same operation as the operation described referring to the flowchart of FIG. 11 of the first embodiment is carried out. While the acquisition subject determining routine corresponds to the communication condition calculating portion 62 of the information acquiring terminal 16 in the first embodiment, the routine corresponds to the communication condition calculating portion 126 of the management information retaining terminal 17 in the second embodiment. Through the operation at step SA23, an acquisition subject table is made, which is a list of images determined to be acquisition subject images. This acquisition subject table corresponds to acquisition subject management information of this embodiment.

At SA24 corresponding to the acquisition subject management information transmitting portion 128, the CPU of the management information retaining terminal 17 transmits the acquisition subject table made at SA23, i.e., an acquisition subject managing portion to the information acquiring terminal 16.

At SA13 corresponding to the acquisition subject management information acquiring portion 104, the CPU of the information acquiring terminal 16 receives the acquisition subject management information transmitted at SA24 to store the acquisition subject management information in the RAM 32 as the acquisition subject table 80.

At SA14 and SA25, the CPU of the information acquiring terminal 16 and that of the management information retaining terminal 17 disconnect the line 14 of which connection is established at SA11 and SA21.

According to the second embodiment, which offers an effect in addition to the effect of the first embodiment, the management information 92 is stored in the RAM 114 of the management information retaining terminal 17 to allow the management information retaining terminal 17 to determine an acquisition subject image. As a result, processes carried out by the information acquiring terminal 16 are reduced.

While the embodiments of the present invention have been described in detail referring to the drawings, the present invention is also applicable in other modes.

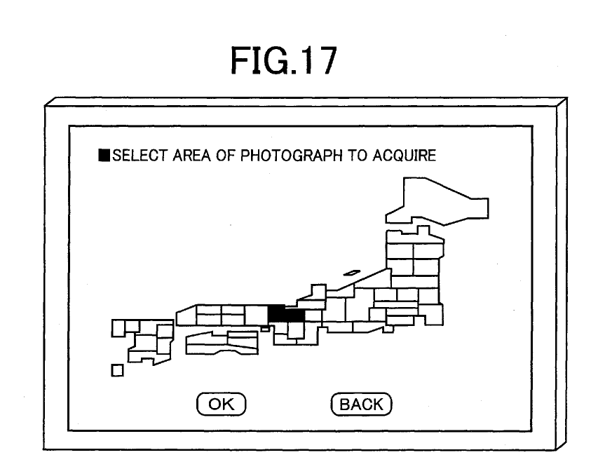

For example, while attribute input using the touch panel display is carried out at the acquisition subject attribute setting portion 52, a graphical interface utilizing graphic may be used in place of such a character-based interface as depicted in FIG. 3 for selection from a list of candidates displayed as character strings in carrying out attribute input. FIG. 17 depicts an example of a graphical interface to be used. In this example, when an attribute is selected from prefectural names in the same manner as in the embodiments, a portion corresponding to a prefecture as a desired attribute to specify is touched on a map of Japanese displayed on the display device 40 of the touch panel display 26, and the touch panel 42 recognizes selection of the touched prefecture.

In the first embodiment, the configuration of the management information retaining terminal 17 is not particularly specified when the management information retaining terminal 17 is capable of storing management information and transmitting the management information to the information acquiring terminal 16 via the line 14 in response to a request from the information acquiring terminal 16, and the configuration of the information retaining terminal 18 is not particularly specified when the information retaining terminal 18 is capable of storing information and transmitting the information to the information acquiring terminal 16 via the line 14 in response to a request from the information acquiring terminal 16. The management information retaining terminal 17 and the information retaining terminal 18, however, may be provided as such a terminal that combines all or any two of three functions equivalent to the information acquiring terminal 16, the management information retaining terminal 17, and the information retaining terminal 18. This applies to the first embodiment and also to the second embodiment.

In the embodiments, the RAM 32 and the RAM 114 are used as information storage portion in the information acquiring terminal 16 and the management information retaining terminal 17, but the information storage portion are not limited to the RAMs 32 and 114. A hard disc drive, etc., may be used as such a storage portion.

While management information is stored in the management information retaining terminal 17 in the embodiments, a mode of storage of management information is not limited to this. The management information may be stored in advance in the RAM 32 of the information acquiring terminal 16. This mode of storage makes communication with the management information retaining terminal 17 unnecessary.

In the embodiments, when a maximum charge amount, the number of images, and an image quality are set as acquisition conditions, the acquisition information determining portion 58 and 122 acquire images having an image quality set within a range satisfying the maximum charge amount in the set number of the images. A mode of image acquisition, however, is not limited to this. For example, when trying to acquire images having a set image quality in the set number of the images results in excess over the maximum charge amount, the images may be acquired in less number or other images having lower resolution may be acquired.

While the attribute of an image is selected from prefectural names in the embodiments, the attribute is not limited to prefectural names but may be selected as any form of relevant information that allows more accurate setting of the attribute of an image to acquire. For example, relevant information may be geographical information other than prefectural names that corresponds to the image, such as a place of photographing the image, time-related information corresponding to the image, such as a place of photographing the image and a season, or evaluative information, such as an evaluation of the image.

In the embodiments, the communication condition calculating portion 62 and 126 each calculates a charge amount as a communication condition for an image that is extracted as an acquisition candidate by each of the acquisition candidate information extracting portion 60 and 124. A mode of communication condition calculation is not limited to this. Specifically, for example, a communication condition may be calculated for every image entered in management information as an acquirable image.

In the embodiments, communication between the information acquiring terminal 16 and the management information retaining terminal 17 is carried out using the line 14 in the same manner as communication between the information acquiring terminal 16 and the information retaining terminal 18 is carried out. A mode of communication is, however, not limited to this. Communication between the information acquiring terminal 16 and the management information retaining terminal 17 may be carried out not using the line 14 that charges depending on a communication distance and a communication time but, for example, using such a communication network as LAN.

While image qualities classified by resolution in the dpi unit are used as information properties in the embodiments, a method of representing image qualities is not limited to this. For example, representing image qualities is not limited to the case of FIG. 6 where three categories of image quality are used, and a unit other than the dpi unit may be used for representing image qualities. A file size (capacity), an image size (number of dots), a compression rate (compressibility), etc., may be used in place of or in addition to an image quality. When electronic data other than an image is used as information defined in the present invention, a file size (capacity), an image size (number of dots), a compression rate (compressibility), etc., may be used in place of an image quality, or an index representing the properties of the information may be used in place of or in addition to the file size, image size, compression rate, etc.

In the acquisition candidate determining routine in the embodiment, when acquisition candidates are read in one by one from the acquisition candidate information table to determine the acquisition candidates to be acquisition subject images, whether a total charge amount and the specified number of images satisfy preset acquisition conditions is determined (SB4 to SB12 of FIG. 11). The acquisition candidate determining routine, however, is not limited to this mode. For example, the acquisition candidate determining routine may be carried out in such a manner that combinations of images made up of acquisition candidates included in the acquisition candidate information tables are set, a total charge amount and the total number of images are calculated for each combination of images, and a combination of images satisfying acquisition conditions are determined to be acquisition subject images.

Although not specifically exemplified, the present invention may variously be implemented in any modified or altered manner without departing from the spirit thereof.

What is claimed is:

1. An information acquiring terminal apparatus that acquires information through a line that charges on basis of a given charge system based on at least one of a communication distance and a communication time, comprising:
an acquisition subject attribute setting portion that sets an attribute of information to acquire depending on input by a user;
an acquisition condition setting portion that sets an acquisition condition including a condition on a maximum charge amount at information acquisition depending on input by the user;
an acquisition subject determining portion that based on a communication condition in a case of acquiring each acquisition candidate information matching an attribute set by the acquisition subject attribute setting portion, determines the acquisition candidate information satisfying the acquisition condition to be acquisition subject information; and
an acquiring portion that acquires the acquisition subject information through the line.

2. The information acquiring terminal apparatus of claim 1, wherein
the communication condition includes a charge amount that is calculated on basis of the given charge system based on at least one of a communication distance in communication for acquiring the acquisition candidate information and a communication time calculated based on a communication rate and a size of the acquisition candidate information.

3. The information acquiring terminal apparatus of claim 1, wherein
the acquisition condition set by the acquisition condition setting portion includes at least one of number of files as the information and properties of the information.

4. The information acquiring terminal apparatus of claim 1, wherein
the attribute set by the acquisition subject attribute setting portion is associated information associated in advance with the information.

5. The information acquiring terminal apparatus of claim 1, wherein
the acquisition subject determining portion comprises:
an acquisition candidate information extracting portion that extracts information matching the attribute set by the acquisition subject attribute setting portion from acquirable information stored in advance, as acquisition candidate information; and
a communication condition calculating portion that based on the given charge system stored in advance, calculates the communication condition including the charge amount in a case of acquiring the each acquisition candidate information.

6. An information acquiring method of acquiring information through a line that charges on basis of a given charge system based on at least one of a communication distance and a communication time comprising:
an acquisition subject attribute setting step of setting an attribute of information to acquire;
an acquisition condition setting step of setting an acquisition condition including a condition on a charge amount at information acquisition,
an acquisition subject determining step of determining each acquisition candidate information satisfying the acquisition condition to be acquisition subject information, based on a communication condition in a case of acquiring the each acquisition candidate information matching an attribute set by the acquisition subject attribute setting step; and
an acquiring step of acquiring the acquisition subject information through the line.

7. A recording medium storing an information acquiring program that causes a computer to acquire information through a line that charges on basis of a given charge system based on at least one of a communication distance and a communication time, the information acquiring program causing the computer to function as:
an acquisition subject attribute setting portion that sets an attribute of information to acquire;
an acquisition condition setting portion that sets an acquisition condition including a condition on a charge amount at information acquisition;
an acquisition subject determining portion that based on a communication condition in a case of acquiring each acquisition candidate information matching an attribute set by the acquisition subject attribute setting portion, determines the acquisition candidate information satisfying the acquisition condition to be acquisition subject information; and
an acquiring portion that acquires the acquisition subject information through the line.
